(19) United States
(12) Patent Application Publication
(10) Pub. No.: US 2025/0377791 A1
(43) Pub. Date: Dec. 11, 2025

(54) MANAGING OPERATIONS PERFORMED USING AN ACCELERATOR IN A COMPUTE EXPRESS LINK (CXL) MEMORY DEVICE

(71) Applicant: Micron Technology, Inc., Boise, ID (US)

(72) Inventor: Melky Arputharaja Siluvainathan, San Jose, CA (US)

(21) Appl. No.: 19/219,082

(22) Filed: May 27, 2025

Related U.S. Application Data
(60) Provisional application No. 63/657,563, filed on Jun. 7, 2024.

(51) Int. Cl. G06F 3/06

(52) U.S. Cl. CPC G06F 3/0611; G06F 3/0659; G06F 3/0673

(57) ABSTRACT

A system can include a memory device and a processing device to perform operations including receiving, from a host system, a first command to configure an accelerator associated with the memory device, wherein the first command comprises one or more operations. The operations include identifying, based on metadata associated with the first command, a command type of the first command. The operations further include determining, based on the command type, a first instruction to configure the accelerator to perform the one or more operations comprised by the first command. The operations further include sending, to the accelerator, the first instruction, wherein the one or more operations are to be performed by the accelerator according to the first instruction.

### REFERENCE TO RELATED APPLICATION

This application claims the priority benefit of U.S. Provisional Patent Application No. 63/657,563, filed June 7, 2024, the entirety of which is incorporated herein by reference.

### TECHNICAL FIELD

Embodiments of the disclosure relate generally to memory sub-systems, and, more specifically, relate to managing the performance of memory access operations using an accelerator in a compute express link (CXL) memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure;

FIG. 2 is a flow diagram of an example method for managing the performance of memory access operations using an accelerator in a compute express link (CXL) memory device, in accordance with some embodiments of the present disclosure.

FIG. 3 is a flow diagram of another example method for managing the performance of memory access operations using an accelerator in a compute express link (CXL) memory device, in accordance with some embodiments of the present disclosure.

FIG. 4 is a block diagram of an example computer system in which embodiments of the present disclosure may operate.

### DETAILED DESCRIPTION

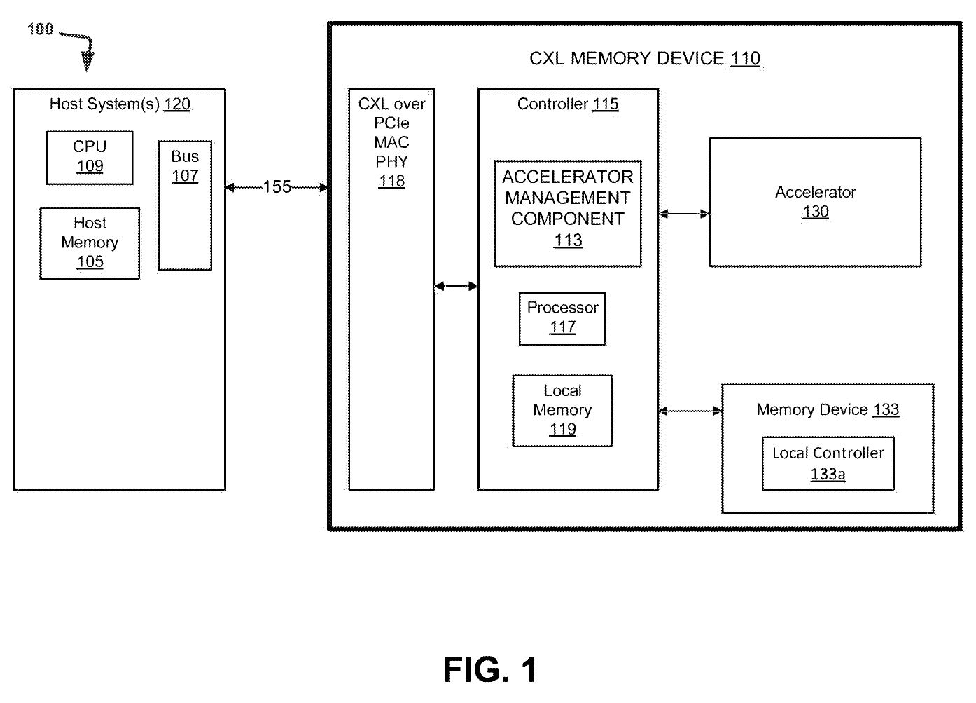

Aspects of the present disclosure are directed to managing the performance of memory access operations using an accelerator in a compute express link (CXL) memory device. A memory sub-system can be a storage device, a memory module, or a combination of a storage device and a memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is a cache-coherent interconnect for processors, memory expansion, and accelerators. A CXL system maintains memory coherency between a central processing unit (CPU) memory space and memory on memory-attached devices, which allows for resource sharing for higher performance, reduced software stack complexity, and a lower overall system cost. Generally, CXL is an interface standard that can support a number of protocols that can run on top of a Peripheral Component Interconnect Express (PCIe), including a CXL.io protocol, a CXL.mem protocol, and a CXL.cache protocol. PCIe is an interface standard used for connecting various hardware components, primarily in high-performance computing systems. The CXL.io protocol is a PCIe-like protocol that can be viewed as an “enhanced” PCIe protocol that is capable of allocating and managing memory for specific tasks and devices. For example, CXL.io can be used for initialization, link-up, device discovery and enumeration, register access, and can provide an interface for I/O devices. The CXL.mem protocol can enable host access to the memory of a memory-attached device using memory-related operations and commands, such as loading and storing commands (e.g., reading and writing commands). This approach can support both volatile and persistent memory devices. The CXL.cache protocol can define host-device interactions to enable efficient caching of host memory with low latency using a request and response approach. Traffic (e.g., Non-Volatile Memory Express (NVMe) traffic) can run through the CXL.io protocol. The CXL.mem and CXL.cache protocols can share a common link layer and transaction layer. Accordingly, the CXL protocols can be multiplexed and transported via a PCIe physical layer.

A memory device that is attached to a host (e.g., a host device, etc.) via CXL can be referred to as a CXL memory device, which can provide additional device bandwidth and capacity to host processors. The CXL memory device is independent of the host device. In some implementations, the CXL memory device can be coupled to an accelerator device. In some implementations, the CXL memory device can serve multiple host systems. In some implementations, certain aspects of the CXL memory device can be managed by a separate entity (e.g., an external logical process) referred to as a fabric manager (also referred to herein as a “fabric management component”). In some examples, the fabric manager can be a distributed application running on bare metal controllers and/or switches.

For some memory devices, high-performance computing (HPC) applications, such as large-scale numerical simulations, image processing, pattern recognition, and data signal processing, can involve the use of large amounts of memory bandwidth and capacity to perform their computations. However, moving data back and forth between storage and processing units can often lead to bottleneck and latency issues, which can be a prevalent issue in data-intensive or memory-intensive applications. Further, different vendors (e.g., customers) can have different specification requirements and/or business requirements and thus may need to send vendor-specific commands for performing memory access operations, where a particular vendor-specific command takes into account the specific requirements of a particular vendor.

Aspects of the present disclosure address the above and other deficiencies by sending vendor-specific commands from a host system to a memory sub-system (e.g., a compute express link (CXL) memory device) to configure an accelerator to perform memory access operations, where the accelerator is part of the memory sub-system. In some embodiments, the accelerator can be a hardware component of the memory sub-system that is designed to accelerate specific computational tasks (e.g., the memory access operations described herein). In some examples, a vendor-specific command is a “mailbox” command, where the command is sent using a memory-mapped input/output (“MMIO”) register interface to a mailbox register of the memory sub-system.

In some embodiments, there can be one or more types of vendor-specific commands. For example, the one or more types of vendor-specific commands can include a “download” vendor-specific command, a “start” vendor-specific command, and a “get status” vendor-specific command. Each type of vendor-specific command can be defined using an operation code (e.g., an “opcode”) that can be specific to the CXL interface. Each opcode can be, for example, a 2-byte opcode. In some embodiments, a “download” vendor-specific command can be a binary file that includes one or more operations to be performed by the accelerator. In response to receiving a “download” vendor-specific command from the host system, a memory sub-system controller can process the “download” vendor-specific command. For example, the memory sub-system controller can read the “download” vendor-specific command, determine the type of the “download” vendor-specific command (e.g., a “download” command), and program the “download” vendor-specific command into a set of memory cells of the accelerator. In some embodiments, a “start” vendor-specific command can be a binary file that includes a command to perform one or more operations specified by a “download” vendor-specific command. The “download” vendor-specific command can be indicated by the “start” vendor-specific command. For example, the command included in the binary file of the “start” vendor-specific command can specify an address at which the one or more operations specified by the “download” vendor-specific command is stored. In some embodiments, in response to receiving a “start” vendor-specific command by the host system, the memory sub-system controller can process the “start” vendor-specific command. For example, the memory sub-system controller can read the “start” vendor-specific command, determine the type of the “start” vendor-specific command (e.g., a “start” command), and send the “start” vendor-specific command to the accelerator. In response to receiving the “start” vendor-specific command, the accelerator can perform the one or more operations specified by the “download” vendor-specific command. In some embodiments, the accelerator can store the results of performing the one or more operations at an address that can be specified by the “download” vendor-specific command and/or “start” vendor-specific command. In some embodiments, a “get result” vendor-specific command can be a binary file that includes a command to send a status of performing a particular operation. In response to receiving the “get result” vendor-specific command, the memory sub-system controller can process the “get result” vendor-specific command. For example, the memory sub-system controller can read the “get result” vendor-specific command, determine the type of the “get result” vendor-specific command (e.g., a “get result” command), and send the “get result” vendor-specific command to the accelerator. In some embodiments, the memory sub-system controller can receive the status from the accelerator. The memory sub-system controller can send the status to the host system using another “get result” vendor-specific command.

In some embodiments, the types of operations that the accelerator can be instructed to perform can include an image processing operation, a pattern recognition operation, a digital signal processing operation, etc. In some embodiments, each vendor-specific command can be identified and/or selected (e.g., by a vendor and/or user) via a software application on the host system.

Advantages of the present disclosure include enabling near-memory computing (NMC), also known as in-memory computing, in order to reduce the time and resources needed to perform computations by performing the computations close to where the data is stored. This can result in faster data access and reduced latency and bottleneck issues by avoiding having to move data back and forth between storage and processing units. NMC also aids in addressing the scalability limitations in some memory devices by adding more memory and processing units. NMC can be especially beneficial for computations involving machine learning, which can be highly memory intensive. There can thus be a more efficient use of memory resources and increased memory bandwidth. Furthermore, aspects of the present disclosure address the challenges that arise with different vendors (e.g., customers) that have different specification requirements and/or business requirements by allowing the different vendors to send vendor-specific commands for performing memory access operations, where a particular vendor-specific command takes into account the specific requirements of a particular vendor. These and other features of the embodiments of the present disclosure are described in more detail with reference to FIG. 1.

FIG. 1 illustrates a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory devices 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the CXL memory device 110, for example, to write data to the CXL memory device 110 and read data from the CXL memory device 110.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL x16).

The host interface 118 can include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 can be a cache-coherent interconnect for processors, memory expansion, and accelerators. The computing system 100 maintains memory coherency between the CPU memory space and memory on memory-attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol, and a CXL.cache protocol. The CXL.io protocol is a PCIe-like protocol that can be viewed as an “enhanced” PCIe protocol capable of allocating and managing memory for specific tasks and devices. For example, CXL.io can be used for initialization, link-up, device discovery and enumeration, register access, and can provide an interface for I/O devices. The CXL.mem protocol can enable host access to the memory of a memory-attached device using memory-related operations and commands, such as loading and storing commands (e.g., reading and writing commands). This approach can support both volatile and persistent memory devices. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The CXL memory device 110 is a memory device that allows the host system 120 to be used as a memory buffer for memory bandwidth expansion, memory capacity expansion, and persistent memory applications, as well as small-scale resource pooling and large-scale resource pooling and sharing.

In some implementations, the CXL memory device can be a device that supports multiple host systems and can be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity. This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) (e.g., a memory device 133, which includes a local controller 133a) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

A CXL memory device controller 115 can communicate with an accelerator 130 to perform memory access operations such as read operations and/or write operations and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application-specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control the operation of the CXL memory device 110, including handling communications between the CXL memory device 110 and the host system 120. The CXL memory device controller 115 can manage operations of CXL memory device 110, such as sending commands to and from the accelerator 130. The CXL memory device controller 115 can include one or more processors 117, which can be multi-core processors. Processors 117 can handle or interact with the components of the accelerator 130, generally through firmware code. The CXL memory device controller 115 can operate under CXL protocol, but other protocols are applicable.

The CXL memory device controller 115 executes computer-readable program code (e.g., software or firmware) executable instructions (herein referred to as “instructions”). The instructions can be executed by various components of CXL memory device controller 115, such as processor 117, logic gates, switches, application-specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. Instructions stored in the CXL memory device 110 can be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 can interact with accelerator 130 for commands and/or memory access operations. The CXL memory device controller 115 can execute the direct memory access (DMA) for data transfers between host system 120 and the accelerator 130 without involvement from CPU 109. The CXL memory device controller 115 can control the data transfer while activating the control path for fetching commands, posting completion and interrupts, and activating the DMA for the actual data transfer between host system 120 and the accelerator 130. The CXL memory device controller 115 can have an error correction module to correct the data fetched from the memory arrays in the accelerator 130.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations from the host system 120 and can convert the commands or operations into instructions or appropriate commands to achieve the desired access to the accelerator 130. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the accelerator 130. The CXL memory device controller 115 can further include host interface circuitry to communicate with the host system 120 via the physical host interface. The host interface circuitry can convert the commands received from the host system into command instructions to access the accelerator 130 as well as convert responses associated with the accelerator 130 into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the accelerator 130.

In some embodiments, the accelerator 130 includes local media controllers that operate in conjunction with CXL memory device controller 115 to execute operations on one or more memory cells of the accelerator 130. An external controller (e.g., CXL memory device controller 115) can externally manage the accelerator 130.

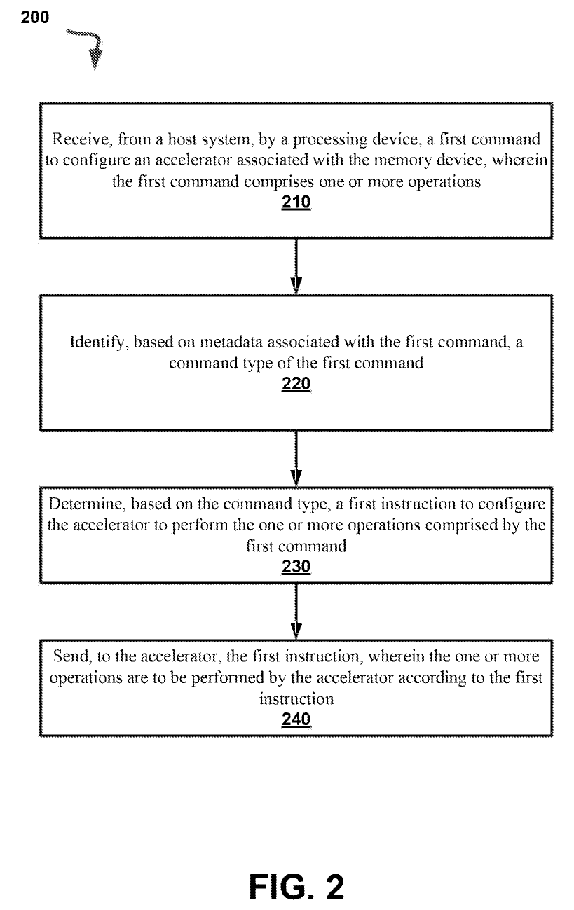

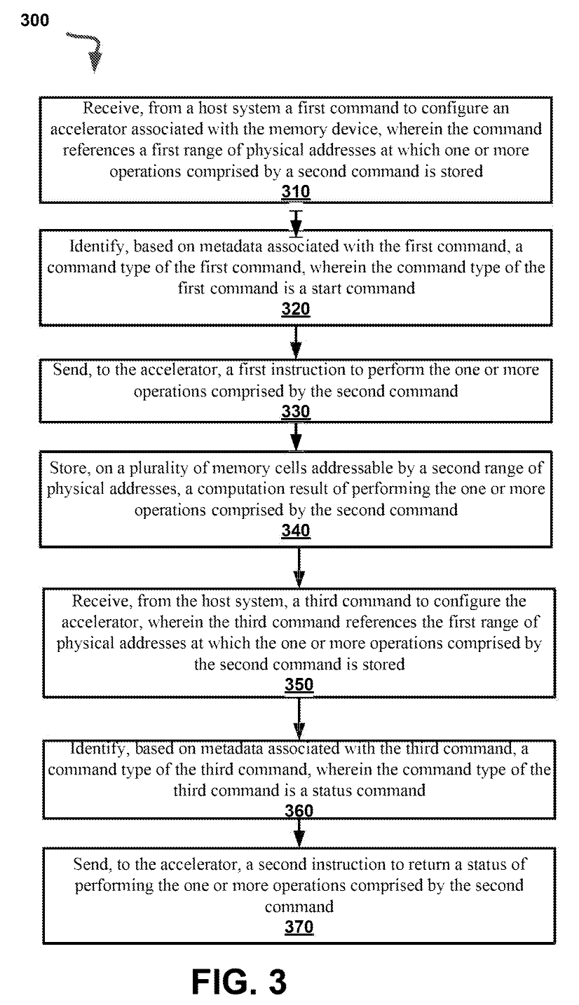

In some embodiments, the CXL memory device 110 includes the accelerator management component 113. In some embodiments, the CXL memory device controller 115 includes at least a portion of the accelerator management component 113. In some embodiments, the accelerator management component 113 is part of the host system 120, an application, or an operating system. Further details regarding the operations of the accelerator management component 113 are described below with reference to FIGS. 2-3.

In some embodiments, the accelerator management component 113 can receive, from a host system (e.g., a host system 120), a first command to configure an accelerator associated with the memory device, where the first command includes one or more operations. The accelerator management component 113 can identify, based on metadata associated with the first command, a command type of the first command. The accelerator management component 113 can determine, based on the command type, a first instruction to configure the accelerator to perform the one or more operations included by the first command. The accelerator management component 113 can send, to the accelerator, the first instruction, where the one or more operations are to be performed by the accelerator according to the first instruction.

It will be appreciated by those skilled in the art that additional circuitry and signals can be provided, and that the components of FIG. 1 have been simplified. It should be recognized that the functionality of the various block components described with reference to FIG. 1 may not necessarily be segregated into distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2 is a flow diagram of an example method 200 for managing the performance of memory access operations using an accelerator in a compute express link (CXL) memory device, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the accelerator management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 210, the processing logic receives a vendor-specific command (e.g., a first command) to configure an accelerator (e.g., the accelerator 130 of FIG. 1) associated with the memory device. In some embodiments, the first command can reference one or more operations to be performed by the accelerator (e.g., memory access operations, such as a write operation, read operation, etc., that can be performed as part of a memory-intensive task and/or a data-intensive task, such as image processing, digital signal processing, pattern recognition, etc.). The processing logic can receive the first command from a host system (e.g., a host system 120 of FIG. 1). In some embodiments, each command can be identified and/or selected (e.g., by a vendor and/or user) via a software application on the host system. In some examples, the first command is a “mailbox” command, where the first command is sent using a memory-mapped input/output (“MMIO”) register interface to a mailbox register of the CXL memory device.

At operation 220, the processing logic identifies a command type of the first command. In some embodiments, the processing logic can identify the command type of the first command based on metadata associated with the first command. For example, the types of command types can include a “download” command, a “start” command, and a “get status” command. Each type of command can be defined using an operation code (e.g., an “opcode”) that can be specific to the CXL interface. Each opcode can be, for example, a 2-byte opcode. In some embodiments, a “download” command can be a binary file that includes the one or more operations to be performed by the accelerator. In some embodiments, a “start” command can be an executable binary file (e.g., executable by the accelerator) that includes a command to perform (e.g., by the accelerator) the one or more operations specified by a “download” command. In some embodiments, a “get result” command can be an executable binary file that includes a command to send a status of performing a particular operation.

At operation 230, the processing logic determines an instruction (e.g., a first instruction and/or a sequence of instructions to be executed by the accelerator) to configure the accelerator to perform the one or more operations referenced by the first command. In some embodiments, the processing logic can determine the first instruction based on the command type. For example, in response to identifying that the command type is a “download” command, the processing logic can create the first instruction to include an indication to store the one or more operations referenced by the first command on a set of memory cells of the accelerator that are addressable by a range of physical addresses. In some embodiments, the first command can include an identifier of the set of memory cells addressable by the range of physical addresses at which to store the one or more operations referenced by the first command. In response to identifying that the command type is a “start” command, the processing logic can create the first instruction to include an indication to perform the one or more operations referenced by the first command. In some embodiments, the first instruction can include an indication to store a computation result of performing the one or more operations referenced by the first command on a set of memory cells of the accelerator that are addressable by a range of physical addresses. In some embodiments, the first command can include an identifier of the set of memory cells addressable by the range of physical addresses at which to store the computation result. In response to identifying that the command type is a “get status” command, the processing logic can create the first instruction to include an indication to return a status of performing the one or more operations referenced by the first command. For example, the status can be “completed,” “in progress,” “not yet started,” etc.

At operation 240, the processing logic sends the first instruction to the accelerator (e.g., over an internal bus). In some embodiments, in response to receiving the first instruction, where the command type is a “download” command, the accelerator can store the one or more operations referenced by the first command according to the first instruction (e.g., on the set of memory cells of the accelerator that are addressable by the range of physical addresses). In some embodiments, in response to receiving the first instruction, where the command type is a “start” command, the accelerator can perform the one or more operations. In some embodiments, in response to receiving the first instruction, where the command type is a “get status” command, the accelerator can send the status of performing the one or more operations to the processing logic. In some embodiments, in response to receiving the status from the accelerator, the processing logic can send the status to the host system.

FIG. 3 is a flow diagram of an example method 300 for managing the performance of memory access operations using an accelerator in a compute express link (CXL) memory device, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the accelerator management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic receives a vendor-specific command (e.g., a first command) to configure an accelerator (e.g., the accelerator 130 of FIG. 1) associated with the memory device. In some embodiments, the first command can reference a set of memory cells of the accelerator that are addressable by a range of physical addresses. In some embodiments, the set of memory cells can store one or more operations (e.g., memory access operations, such as a write operation, read operation, etc., that can be performed as part of a memory-intensive task and/or a data-intensive task, such as image processing, digital signal processing, pattern recognition, etc.), where the one or more operations are referenced by another (e.g., a second) command, where the second command is a “download” command. The processing logic can receive the first command and/or the second command from a host system (e.g., a host system 120 of FIG. 1). In some embodiments, each command can be identified and/or selected (e.g., by a vendor and/or user) via a software application on the host system. In some examples, each command is a “mailbox” command, where each command is sent using a memory-mapped input/output (“MMIO”) register interface to a mailbox register of the CXL memory device.

At operation 320, the processing logic identifies a command type of the first command. In some embodiments, the processing logic can identify the command type of the first command based on metadata associated with the first command. In some embodiments, the processing logic can identify that the command type is a “start” command.

At operation 330, the processing logic sends a first instruction to the accelerator (e.g., over a CXL bus) to perform the one or more operations referenced by the second command. In some embodiments, the processing logic determines the first instruction to configure the accelerator to perform the one or more operations referenced by the second command. In some embodiments, the processing logic can determine the first instruction based on the command type of the first command. For example, in response to identifying that the command type is a “start” command, the processing logic can create the first instruction to include an indication to perform the one or more operations referenced by the second command. In some embodiments, in response to receiving the first instruction, the accelerator can perform the one or more operations.

At operation 340, the processing logic stores the computation result of performing the one or more operations referenced by the second command on a set of memory cells of the accelerator that are addressable by a range of physical addresses. In some embodiments, the first instruction can include an indication to store the computation result of performing the one or more operations referenced by the second command on the set of memory cells of the accelerator that are addressable by the range of physical addresses. In some embodiments, the second command and/or the first command can include an identifier of the set of memory cells addressable by the range of physical addresses at which to store the computation result

At operation 350, the processing logic receives another (e.g., a third) command to configure the accelerator. In some embodiments, the third command can reference a set of memory cells of the accelerator that are addressable by a range of physical addresses. In some embodiments, the set of memory cells can store the one or more operations referenced by the second command. The processing logic can receive the third command from the host system (e.g., a host system 120 of FIG. 1). In some embodiments, the third command can be identified and/or selected (e.g., by a vendor and/or user) via a software application on the host system.

At operation 360, the processing logic identifies a command type of the third command. In some embodiments, the processing logic can identify the command type of the third command based on metadata associated with the third command. In some embodiments, the processing logic can identify that the command type is a “get status” command.

At operation 370, the processing logic sends another (e.g., a second) instruction to the accelerator (e.g., over a CXL bus) to return a status of performing the one or more operations referenced by the second command. In some embodiments, the processing logic determines the second instruction to configure the accelerator to return the status of performing the one or more operations referenced by the second command. In some embodiments, the processing logic can determine the second instruction based on the command type of the third command. For example, in response to identifying that the command type is a “get status” command, the processing logic can create the second instruction to include an indication to return a status of performing the one or more operations referenced by the first command. For example, the status can be “completed,” “in progress,” “not yet started,” etc. In some embodiments, in response to receiving the second instruction, the accelerator can send the status of performing the one or more operations to the processing logic. In some embodiments, in response to receiving the status from the accelerator, the processing logic can send the status to the host system.

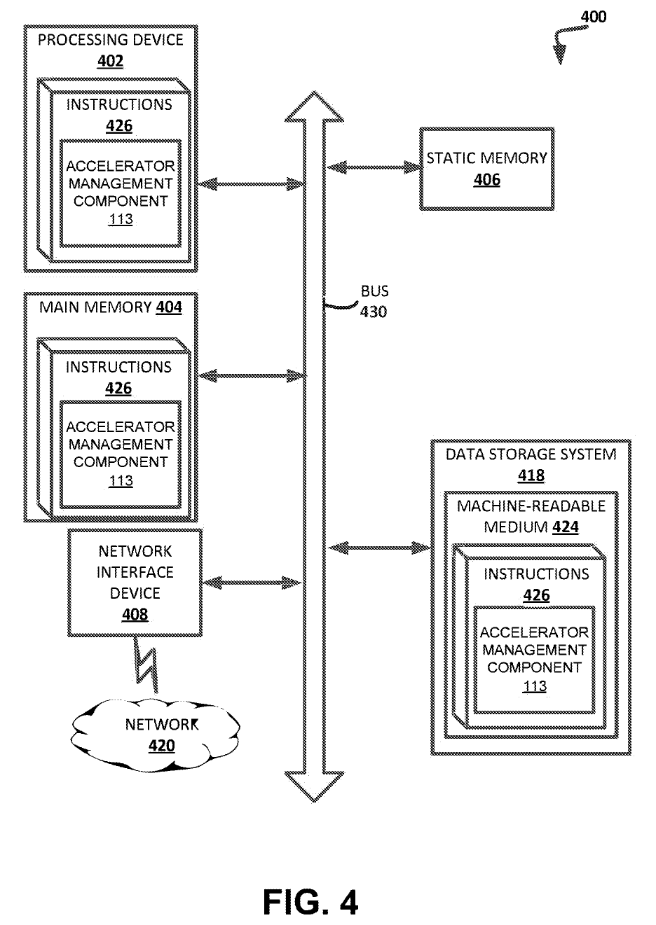

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the accelerator management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to the accelerator management component 113 of FIG. 1 and methods 200-300 of FIGS. 2-3. While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising: a memory device; and a processing device, operatively coupled with the memory device, to perform operations comprising: receiving, from a host system, a first command to configure an accelerator associated with the memory device, wherein the first command comprises one or more operations; identifying, based on the first command, a command type of the first command; determining, based on the command type, a first instruction to configure the accelerator to perform the one or more operations comprised by the first command; and sending, to the accelerator, the first instruction, wherein the one or more operations are to be performed by the accelerator according to the first instruction.

2. The system of claim 1, wherein the command type of the first command is a download command, and wherein the first instruction further comprises an indication to store the one or more operations on a plurality of memory cells of the accelerator addressable by a range of physical addresses.

3. The system of claim 2, wherein the processing device is to perform operations further comprising: receiving, from the host system, a second command to configure the accelerator, wherein the second command references the range of physical addresses at which the one or more operations comprised by the first command is stored; identifying, based on metadata associated with the second command, a command type of the second command, wherein the command type of the second command is a start command;
and sending, to the accelerator, a second instruction to perform the one or more operations comprised by the first command.

4. The system of claim 1, wherein the command type of the first command is a status command.

5. The system of claim 2, wherein the processing device is to perform operations further comprising: receiving, from the host system, a second command to configure the accelerator, wherein the second command references the range of physical addresses at which the one or more operations comprised by the first command is stored; identifying, based on metadata associated with the second command, a command type of the second command, wherein the command type of the second command is a status command;
and sending, to the accelerator, a second instruction to return a status of performing the one or more operations comprised by the first command.

6. The system of claim 3, wherein the processing device is to perform operations further comprising: storing, on a second plurality of memory cells of the accelerator addressable by a second range of physical addresses, a computation result of performing the one or more operations, wherein the second command identifies the second plurality of memory cells addressable by the second range of physical addresses.

7. The system of claim 1, wherein each of the processing device and the memory device is connected to the host system via a respective plurality of Compute Express Link (CXL) links.

8. A non-transitory computer-readable storage medium comprising instructions that, when executed by a processing device, cause the processing device to perform operations comprising: receiving, from a host system, a first command to configure an accelerator associated with the memory device, wherein the first command comprises one or more operations; identifying, based on metadata associated with the first command, a command type of the first command;
determining, based on the command type, a first instruction to configure the accelerator to perform the one or more operations comprised by the first command; and
sending, to the accelerator, the first instruction, wherein the one or more operations are to be performed by the accelerator according to the first instruction.

9. The non-transitory computer-readable storage medium of claim 8, wherein the command type of the first command is a download command, and wherein the first instruction further comprises an indication to store the one or more operations on a plurality of memory cells of the accelerator addressable by a range of physical addresses.

10. The non-transitory computer-readable storage medium of claim 9, wherein the operations further comprise: receiving, from the host system, a second command to configure the accelerator, wherein the second command references the range of physical addresses at which the one or more operations comprised by the first command is stored; identifying, based on metadata associated with the second command, a command type of the second command, wherein the command type of the second command is a start command;
and sending, to the accelerator, a second instruction to perform the one or more operations comprised by the first command.

11. The non-transitory computer-readable storage medium of claim 8, wherein the command type of the first command is a status command.

12. The non-transitory computer-readable storage medium of claim 9, wherein the operations further comprise: receiving, from the host system, a second command to configure the accelerator, wherein the second command references the range of physical addresses at which the one or more operations comprised by the first command is stored;
identifying, based on metadata associated with the second command, a command type of the second command, wherein the command type of the second command is a status command;
and sending, to the accelerator, a second instruction to return a status of performing the one or more operations comprised by the first command.

13. The non-transitory computer-readable storage medium of claim 10, wherein the operations further comprise: storing, on a second plurality of memory cells of the accelerator addressable by a second range of physical addresses, a computation result of performing the one or more operations, wherein the second command identifies the second plurality of memory cells addressable by the second range of physical addresses.

14. The non-transitory computer-readable storage medium of claim 8, wherein each of the processing device and the memory device is connected to the host system via a respective plurality of Compute Express Link (CXL) links.

15. A method comprising: receiving, from a host system, by a processing device, a first command to configure an accelerator associated with the memory device, wherein the first command comprises one or more operations; identifying, based on metadata associated with the first command, a command type of the first command; determining, based on the command type, a first instruction to configure the accelerator to perform the one or more operations comprised by the first command; and sending, to the accelerator, the first instruction, wherein the one or more operations are to be performed by the accelerator according to the first instruction.

16. The method of claim 15, wherein the command type of the first command is a download command, and wherein the first instruction further comprises an indication to store the one or
more operations on a plurality of memory cells of the accelerator addressable by a range of physical addresses.

17. The method of claim 16, further comprising: receiving, from the host system, a second command to configure the accelerator, wherein the second command references the range of physical addresses at which the one or more operations comprised by the first command is stored; identifying, based on metadata associated with the second command, a command type of the second command, wherein the command type of the second command is a start command;
and sending, to the accelerator, a second instruction to perform the one or more operations comprised by the first command.

18. The method of claim 17, further comprising: receiving, from the host system, a second command to configure the accelerator, wherein the second command references the range of physical addresses at which the one or more operations comprised by the first command is stored; identifying, based on metadata associated with the second command, a command type of the second command, wherein the command type of the second command is a status command;
and sending, to the accelerator, a second instruction to return a status of performing the one or more operations comprised by the first command.

19. The method of claim 18, further comprising: storing, on a second plurality of memory cells of the accelerator addressable by a second range of physical addresses, a computation result of performing the one or more operations, wherein the second command identifies the second plurality of memory cells addressable by the second range of physical addresses.

20. The method of claim 15, wherein each of the processing device and the memory device is connected to the host system via a respective plurality of Compute Express Link (CXL) links.
